(19) United States
(12) Patent Application Publication
(10) Pub. No.: US 2016/0307048 A1
(43) Pub. Date: Oct. 20, 2016

(54) SIMULATING CAMERA NODE OUTPUT FOR PARKING POLICY MANAGEMENT SYSTEM

(71) Applicant: General Electric Company, Schenectady, NY (US)

(72) Inventors: Lokesh Babu Krishnamoorthy, San Ramon, CA (US); Siong Ming Lim, San Ramon, CA (US); Madhavi Vudumula, San Ramon, CA (US); Aileen Margaret Hackett, San Ramon, CA (US)

(21) Appl. No.: 15/099,373

(22) Filed: Apr. 14, 2016

Related U.S. Application Data
(60) Provisional application No. 62/149,341, filed on Apr. 17, 2015.
(60) Provisional application No. 62/149,345, filed on Apr. 17, 2015.
(60) Provisional application No. 62/149,350, filed on Apr. 17, 2015.
(60) Provisional application No. 62/149,354, filed on Apr. 17, 2015.
(60) Provisional application No. 62/149,359, filed on Apr. 17, 2015.

(51) Int. Cl. G06K 9/00; G06T 7/00; H04N 5/247

(52) U.S. Cl. CPC G06K 9/00771; H04N 5/247; G06T 7/004; G06T 2207/30264

(57) ABSTRACT

A system comprising a computer-readable storage medium storing at least one program and a method for simulating output of camera nodes configured to monitor parking is presented. The method may include generating a simulation file that includes entries mimicking camera node output, where each entry represents metadata associated with an image of a parking space and includes a timestamp and a set of pixel coordinates representing a location of a vehicle in the image. The method further includes simulating the output of the camera nodes using the simulation file. The simulating of the output of the particular camera node may include chronologically reading entries from the simulation file according to a chronology of the entries defined by the time stamps of each entry. The simulating of the output further may include generating a data packet for each entry and transmitting the data packet to a network-based processing system.

### CROSS REFERENCE TO RELATED APPLICATIONS

This patent application claims the benefit of priority to U.S. Provisional Patent Application Ser. No. 62/149,341, titled “INTELLIGENT CITIES—COORDINATES OF BLOB OVERLAP,” filed Apr. 17, 2015, and to U.S. Provisional Patent Application Ser. No. 62/149,345, titled “INTELLIGENT CITIES—REAL-TIME STREAMING AND RULES ENGINE,” filed Apr. 17, 2015, and to U.S. Provisional Patent Application Ser. No. 62/149,350, titled “INTELLIGENT CITIES—DETERMINATION OF UNIQUE VEHICLE,” filed Apr. 17, 2015, and to U.S. Provisional Patent Application Ser. No. 62/149,354, titled “INTELLIGENT CITIES—USER INTERFACES,” filed Apr. 17, 2015, and to U.S. Provisional Patent Application Ser. No. 62/149,359, titled “INTELLIGENT CITIES—DATA SIMULATOR,” filed Apr. 17, 2015, each of which is hereby incorporated by reference in its entirety.

### TECHNICAL FIELD

The subject matter disclosed herein relates to parking management and parking policy enforcement. In particular, example embodiments relate to systems and methods for simulating parking metadata output by one or more camera nodes used for detecting parking policy violations.

### BACKGROUND

In many municipalities, the regulation and management of vehicle parking poses challenges for municipal governments. Municipal governments frequently enact various parking policies (e.g., rules and regulations) to govern the parking of vehicles along city streets and other areas. As an example, time limits may be posted along a street and parking fines may be imposed on vehicle owners who park their vehicles for longer than the posted time. Proper management and enforcement of parking polices provide benefits to these municipalities in that traffic congestion is reduced by forcing motorists who wish to park for long periods to find suitable off-street parking, which in turn creates vacancies for more convenient on street parking for use by other motorists who wish to stop only for short term periods. Further, the parking fines imposed on motorists who violate parking regulations create additional revenue for the municipality. However, ineffectively enforcing parking policies results in a loss of revenues for the municipalities.

A fundamental technical problem encountered by parking enforcement personnel in effectively enforcing parking policies is actually detecting when vehicles are in violation of a parking policy. Conventional techniques for detection of parking policy violations include using either parking meters installed adjacent to each parking space or a technique referred to as “tire-chalking.” Typical parking policy enforcement involves parking enforcement personnel circulating around their assigned parking zones repetitively to inspect whether parked vehicles are in violation of parking policies based on either the parking meters indicating that the purchased parking period has expired, or a visual inspection of previously made chalk-marks performed once the parking time limit has elapsed. With either technique, many violations are missed either because the parking attendant was unable to spot the violation before the vehicle left or because of motorist improprieties (e.g., by hiding or erasing a chalk-mark).

### BRIEF DESCRIPTION OF THE DRAWINGS

Various ones of the appended drawings merely illustrate example embodiments of the present inventive subject matter and cannot be considered as limiting its scope.

FIG. 1 is an architecture diagram showing a network system having a client-server architecture configured for monitoring parking policy violations using actual camera node output data, according to some embodiments.

FIG. 2 is an interaction diagram illustrating example interactions between components of the network system illustrated in FIG. 1, according to some embodiments.

FIG. 3 is a block diagram illustrating various modules comprising a parking policy monitoring system, which is provided as part of the network system, according to some embodiments.

FIG. 4 is an architecture diagram showing a network system having a client-server architecture configured for monitoring parking policy violations using simulated camera node output data, according to some embodiments.

FIG. 5 is an interaction diagram illustrating example interactions between components of the network system illustrated in FIG. 4, according to some embodiments.

FIG. 6 is a flowchart illustrating a method for providing simulated camera node output data, according to some embodiments.

FIG. 7 is a flowchart illustrating a method for generating a camera node output simulation file, according to some embodiments.

FIG. 8 is a flowchart illustrating a method for generating an entry in the camera node output simulation file, according to some embodiments.

FIG. 9 is a conceptual diagram illustrating a portion of a node output simulation file, according to some embodiments.

FIG. 10 is a flowchart illustrating a method for simulating camera node output, according to some embodiments.

FIG. 11 is a flowchart illustrating a method for monitoring parking policy violations, according to some embodiments.

FIGS. 12A-12D are interface diagrams illustrating portions of an example user interface (UI) for monitoring parking rule violations in a parking zone, according to some embodiments.

FIG. 13 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Aspects of the present disclosure involve systems and methods for monitoring parking policy violations. In example embodiments, data is streamed from multiple camera nodes to a parking policy management system where the data is processed to determine if parking spaces are occupied and if vehicles occupying the parking spaces are in violation of parking policies. The data streamed by the camera nodes includes metadata that includes information describing images (also referred to herein as “parking metadata”) captured by the camera nodes along with other information related to parking space occupancy. Each camera node may be configured such that the images captured by the node depict at least one parking space, and in some instances, vehicles parked in the parking spaces or in motion near the parking spaces. Each camera node is specially configured (e.g., with application logic) to analyze the captured images to provide pixel coordinates of vehicles in the image as part of the metadata along with a timestamp, a camera identifier, a location identifier, and a vehicle identifier.

The metadata provided by the camera nodes may be sent via a message protocol to a messaging queue of the parking policy management system where back-end analytics store the pixel coordinate data in a persistent format to a back-end database. Sending the metadata rather than the images themselves provides the ability to send locations of parked or moving vehicles in great numbers for processing and removes dependency on camera nodes to send images in bulk for processing. Further, by sending the metadata rather than the images, the system reduces the amount of storage needed to process parking rule validations.

Parking policies discussed herein may include a set of parking rules that regulate the parking of vehicles in the parking spaces. The parking rules may, for example, impose time constraints (e.g., time limits) on vehicles parked in parking spaces. The processing performed by the parking policy management system includes performing a number of validations to determine whether the parking space is occupied and whether the vehicle occupying the space is in violation of one or more parking rules included in the parking policy. In performing these validations, the parking policy management system translates the pixel coordinates of vehicles received from the camera nodes into global coordinates (e.g., real-world coordinates) and compares the global coordinates of the vehicles to known coordinates of parking spaces. The parking policy management system may process the data in real-time or in mini batches of data at a configurable frequency.

The parking policy management system includes a parking rules engine to process data streamed from multiple camera nodes to determine, in real-time, if a parked vehicle is in violation of a parking rule. The parking rules engine provides the ability to run complex parking rules on real-time streaming data, and flag data if a violation is found in real-time. The parking rules engine may further remove dependency on camera nodes to determine if a vehicle is in violation. Multiple rules may apply for a parking space or zone and the parking rules engine may determine which rules apply based on the timestamp and other factors. The parking rules engine enables complex rule processing to occur using the data streamed from the camera nodes and the parking spaces or zones stored rules data.

By processing the data in the manner described above, the parking policy management system provides highly efficient real-time processing of data (e.g., parking metadata) from multiple camera nodes. Further, the parking policy management system may increase the speed with which parking violations are identified, and thereby reduce costs in making such determinations.

Testing of systems with a dependency on input data from physical cameras, such as the system mentioned above, can be difficult because any logistical or physical environment issue could delay testing. Further aspects of the present disclosure address this issue, among others, by providing a camera node simulation system to mirror and stream parking metadata (e.g., data received from camera nodes) to provide to a processing system, such as the parking policy management system, for testing and performance tuning. In this manner, multiple cameras that have yet to be deployed in the field may be simulated, thereby enabling performance tuning ahead of actual deployment. In this way, integrated testing may progress without a dependency on actual cameras and other communication nodes.

In example embodiments, the camera node simulation system includes a file generator and a simulation engine. The file generator is responsible for generating a camera node output simulation file that mimics the output (e.g., parking metadata) of one or more camera nodes. The camera node output simulation file includes data in a format that is able to be processed by a back-end computing system (e.g., forming part of the parking policy management system). The data may, for example, include a camera node identifier, a camera identifier, an object identifier, a timestamp, and coordinates for the object (e.g., a parked vehicle).

The simulation engine takes the simulation file as its primary input along with an identifier of the back-end processing system (e.g., a uniform resource identifier (URI)) where messages should be sent for back-end testing. Also, the simulation engine may take in a number of user-specified parameters. For example, a “Loop” parameter may be used to indicate the number of times to loop through the simulation files to simulate additional messages. As another example, an “Interval Time” parameter may be used to indicate the interval time between the camera publishing data packets. The simulation engine may then use the camera node simulation file to stream simulated output data to a server where, for example, in-memory processing may determine if a parking space is occupied and if there is a parking violation. The in-memory processing includes a number of validations to determine if the parking space is occupied and whether the vehicle parked is in violation of the parking space rules. The data may be processed in real-time and can be simulated from multiple camera nodes, in multiple locations.

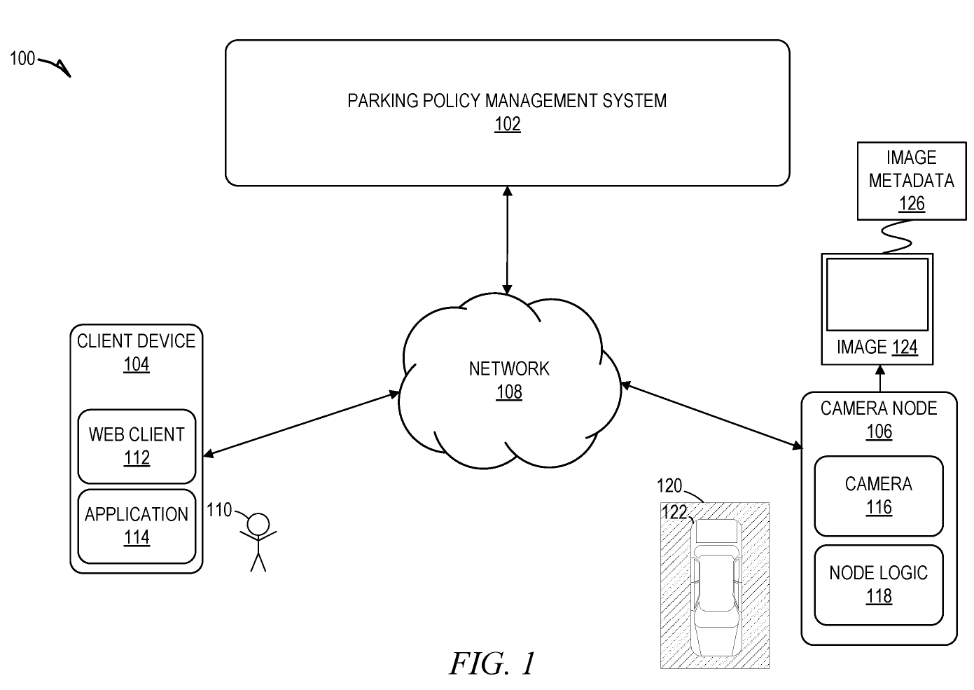

FIG. 1 is an architecture diagram showing a network system 100 having a client-server architecture configured for monitoring parking policy violations, according to an example embodiment. While the network system 100 shown in FIG. 1 may employ a client-server architecture, the present inventive subject matter is, of course, not limited to such an architecture, and could equally well find application in an event-driven, distributed, or peer-to-peer architecture system, for example. Moreover, it shall be appreciated that although the various functional components of the network system 100 are discussed in the singular sense, multiple instances of one or more of the various functional components may be employed.

As shown, the network system 100 includes a parking policy management system 102, a client device 104, and a camera node 106, all communicatively coupled to each other via a network 108. The parking policy management system 102 may be implemented in a special-purpose (e.g., specialized) computer system, in whole or in part, as described below.

Also shown in FIG. 1 is a user 110, who may be a human user (e.g., a parking attendant, parking policy administrator, or other such parking enforcement personnel), a machine user (e.g., a computer configured by a software program to interact with the client device 104), or any suitable combination thereof (e.g., a human assisted by a machine or a machine supervised by a human). The user 110 is associated with the client device 104 and may be a user of the client device 104. For example, the client device 104 may be a desktop computer, a vehicle computer, a tablet computer, a navigational device, a portable media device, a smart phone, or a wearable device (e.g., a smart watch, smart glasses, smart clothing, or smart jewelry) belonging to the user 110.

The client device 104 may also include any one of a web client 112 or application 114 to facilitate communication and interaction between the user 110 and the parking policy management system 102. In various embodiments, information communicated between the parking policy management system 102 and the client device 104 may involve user-selected functions available through one or more (UIs. The UIs may be specifically associated with the web client 112 (e.g., a browser) or the application 114. Accordingly, during a communication session with the client device 104, the parking policy management system 102 may provide the client device 104 with a set of machine-readable instructions that, when interpreted by the client device 104 using the web client 112 or the application 114, cause the client device 104 to present the UI and transmit user input received through such UIs back to the parking policy management system 102. As an example, the UIs provided to the client device 104 by the parking policy management system 102 allow users to view information regarding parking space occupancy and parking policy violations overlaid on a geospatial map.

The network 108 may be any network that enables communication between or among systems, machines, databases, and devices (e.g., between parking policy management system 102 and the client device 104). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof. Accordingly, the network 108 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a WiFi network or WiMax network), or any suitable combination thereof. Any one or more portions of the network 108 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

The camera node 106 includes a camera 116 and node logic 118. The camera 116 may be any of a variety of image capturing devices configured for recording images (e.g., single images or video). The camera node 106 may be or include a street light pole, and may be positioned such that the camera 116 captures images of a parking space 120. The node logic 118 may configure the camera node 106 to analyze images 124 recorded by the camera 116 to provide pixel coordinates of a vehicle 122 that may be shown in an image 124 along with the parking space 120. The camera node 106 transmits parking metadata 126 that includes the pixel coordinates of the vehicle 122 to the parking policy management system 102 (e.g., via a messaging protocol) over the network 108. The parking policy management system 102 uses the pixel coordinates included in the parking metadata 126 received from the camera node 106 to determine whether the vehicle 122 is occupying (e.g., parked in) the parking space 120. For as long as the vehicle 122 is included in images recorded by the camera 116, the camera node 106 continues to transmit the pixel coordinates of the vehicle 122 to the parking policy management system 102, and the parking policy management system 102 uses the pixel coordinates to monitor the vehicle 122 to determine if the vehicle 122 is in violation of one or more parking rules included in a parking policy that is applicable to the parking space 120.

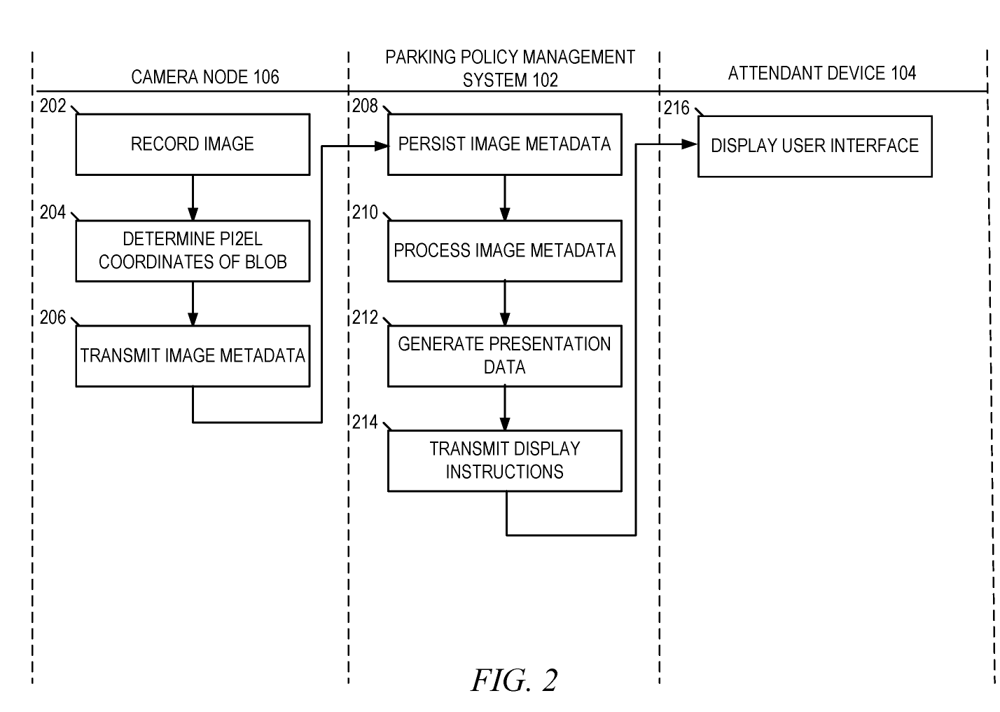

FIG. 2 is an interaction diagram illustrating example interactions between components of the network system 100, according to some embodiments. In particular, FIG. 2 illustrates example interactions that occur between the parking policy management system 102, client device 104, and the camera node 106 as part of monitoring parking policy violations occurring with respect to the parking space 120.

As shown, at operation 202 the camera 116 of the camera node 106 records an image 124. As noted above, the camera 116 is positioned such that the camera 116 records images that depict the parking space 120. The image 124 recorded by the camera 116 may further depict the vehicle 122 that, upon initial processing, appears to the camera node 106 as a “object” in the image 124.

At operation 204, the node logic 118 configures the camera node 106 to perform image analysis on the image 124 to determine the pixel coordinates of the object. The pixel coordinates are a set of spatial coordinates that identify the location of the object within the image itself.

At operation 206, the camera node 106 transmits the parking metadata 126 associated with the recorded image 124 over the network 108 to the parking policy management system 102. The camera node 106 may transmit the metadata 126 as a data packet using a standard messaging protocol. The parking metadata 126 includes the pixel coordinates of the object (e.g., the vehicle 122) along with a timestamp (e.g., a date and time the image was recorded), a camera identifier (e.g., identifying the camera 116), a location identifier (e.g., identifying the camera node 106 or a location of the camera node 106), and an object identifier (e.g., a unique identifier assigned to the vehicle 122). The camera node 106 may continuously transmit (e.g., at predetermined intervals) the parking metadata while the vehicle 122 continues to be shown in image recorded by the camera 116.

At operation 208, the parking policy management system 102 persists (e.g. saves) the parking metadata 126 to a data store (e.g., a database). In persisting the parking metadata 126 to the data store, the parking policy management system 102 may create or modify a data object associated with the camera node 106 or the parking space 120. The created or modified data object includes the received parking metadata 126. As the camera node 106 continues to transmit subsequent parking metadata, the parking policy management system 102 may store the subsequent parking metadata received from the camera node 106 in the same data object or in another data object that is linked to the same data object. In this way, the parking policy management system 102 maintains a log of parking activity with respect to the parking space 120. It shall be appreciated that the parking policy management system 102 may be communicatively coupled to multiple instances of the camera node 106 that record images showing other parking spaces, and the parking policy management system 102 may accordingly maintain separate records for each camera node 106 and/or parking spaces so as to maintain a log of parking activity with respect to a group of parking spaces.

At operation 210, the parking policy management system 102 processes the parking metadata 126 received from the camera node 106. The processing of the parking metadata 126 may, for example, include determining an occupancy status of the parking space 120. The occupancy status of the parking space 120 may be either occupied (e.g., a vehicle is parked in the parking space) or unoccupied (e.g., no vehicle is parked in the parking space). Accordingly, the determining of the occupancy status of the parking space 120 includes determining whether the vehicle 122 is parked in the parking space 120. In determining that the vehicle 122 is parked in the parking space 120, the parking policy management system 102 verifies that the location of the vehicle 122 overlaps the location of the parking space 120, and the parking policy management system 102 further verifies that the vehicle is still (e.g., not in motion). If the parking policy management system 102 determines the vehicle 122 is in motion, the parking policy management system 102 flags the vehicle 122 for further monitoring.

Upon determining that the parking space 120 is occupied by the vehicle 122 (e.g., the vehicle 122 is parked in the parking space 120), the parking policy management system 102 determines whether the vehicle 122 is in violation of a parking rule that is applicable to the parking space 120. In determining whether the vehicle is in violation of a parking rule, the parking policy management system 102 monitors further metadata transmitted by the camera node 106 (e.g., metadata including information describing subsequent images captured by the camera 116). The parking policy management system 102 further accesses a parking policy specifically associated with the parking space 120. The parking policy includes one or more parking rules. The parking policy may include parking rules that have applicability only to certain times of day, or days of the week, for example. Accordingly, the determining of whether the vehicle is in violation of a parking rule includes determining which, if any, parking rules apply, and the applicability of parking rules may be based on the current time of day or current day of the week.

Parking rules may, for example, impose a time limit on parking in the parking space 120. Accordingly, the determining of whether the vehicle 122 is in violation of a parking rule may include determining an elapsed time since the vehicle first parked in the parking space 120 and comparing the elapsed time to the time limit imposed by the parking rule.

At operation 212, the parking policy management system 102 generates presentation data corresponding to a user interface. The presentation data may include a geospatial map of the area surrounding the parking space 120, visual indicators of parking space occupancy, visual indicators of parking rule violations, visual indicators of locations visited by the vehicle 122 (e.g., if vehicle 122 is determined to be in motion), identifiers of specific parking rules being violated, images of the vehicle 122, and textual information describing the vehicle (e.g., make, model, color, and license plate number). Accordingly, in generating the presentation data, the parking policy management system 102 may retrieve, from the camera node 106, the first image showing the vehicle 122 parked in the parking space 120 (e.g., the first image from which the parking policy management system 102 can determine the vehicle 122 is parked in the parking space 120), and a subsequent image from which the parking policy management system 102 determined that the vehicle 122 is in violation of the parking rule (e.g., the image used to determine the vehicle 122 is in violation of the parking rule). The UI may include the geospatial map overlaid with visual indicators of parking space occupancy and parking rule violations that may be selectable (e.g., through appropriate user input device interaction with the UI) to present additional UI elements that include the images of the vehicle 122 and textual information describing the vehicle.

At operation 214, the parking policy management system 102 transmits the presentation data to the client device 104 to enable the client device 104 to present the UI on a display of the client device 104. Upon receiving the presentation data, the client device 104 may temporarily store the presentation data to enable the client device to display the UI, at operation 216.

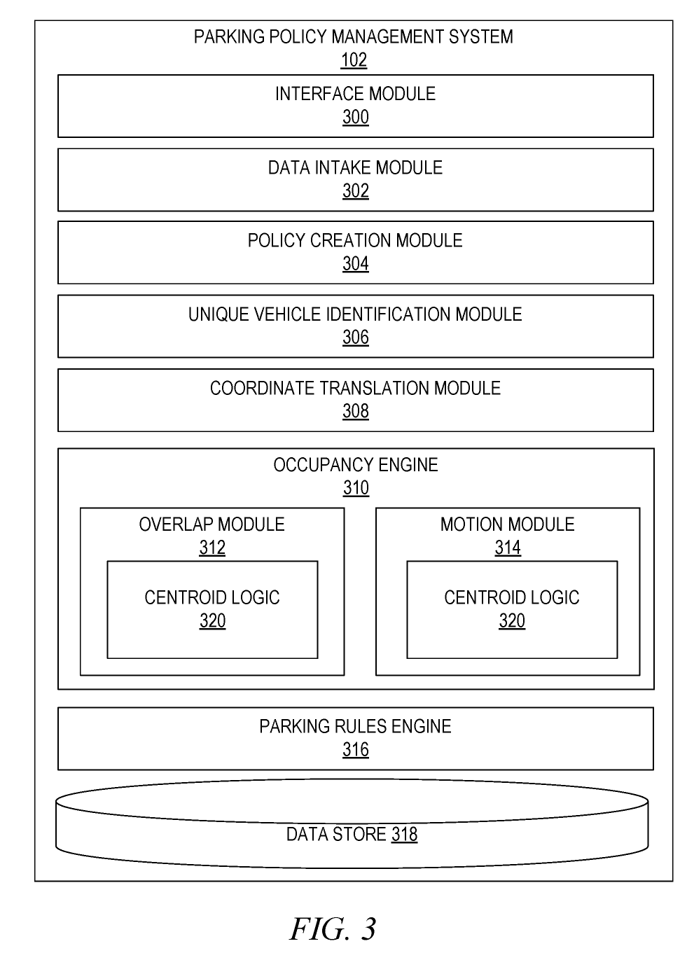

FIG. 3 is a block diagram illustrating various modules comprising a parking policy management system 102, which is provided as part of the network system, according to some embodiments. To avoid obscuring the inventive subject matter with unnecessary detail, various functional components (e.g., modules, engines, and databases) that are not germane to conveying an understanding of the inventive subject matter have been omitted from FIG. 2. However, a skilled artisan will readily recognize that various additional functional components may be supported by the parking policy management system 102 to facilitate additional functionality that is not specifically described herein.

As shown, the parking policy management system 102 includes: an interface module 300; a data intake module 302; a policy creation module 304; a unique vehicle identification module 306; a coordinate translation module 308; an occupancy engine 310 comprising an overlap module 312 and a motion module 314; a parking rules engine 316; and a data store 318. Each of the above referenced functional components of the parking policy management system 102 are configured to communicate with each other (e.g., via a bus, shared memory, a switch, or application programming interfaces (APIs)). Any one or more of functional components illustrated in FIG. 3 and described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, any of the functional components illustrated in FIG. 3 may be implemented together or separately within a single machine, database, or device may be distributed across multiple machines, databases, or devices.

The interface module 300 receives requests from the client device 104 and communicates appropriate responses to the client device 104. The interface module 300 may receive requests from devices in the form of Hypertext Transfer Protocol (HTTP) requests or other web-based, API requests. For example, the interface module 300 provides a number of interfaces (e.g., APIs or UIs that are presented by the device 104) that allow data to be received by the parking policy management system 102.

For example, the interface module 300 may provide a policy creation UI that allows the user 110 of the client device 104 to create parking policies (e.g., a set of parking rules) associated with a particular parking zone (e.g., a set of parking spaces). The interface module 300 also provides parking attendant UIs to the client device 104 to assist the user 110 (e.g., parking attendants or other such parking enforcement personnel) in monitoring parking policy violations in their assigned parking zone. To provide a UI to the client device 104, the interface module 300 transmits a set of machine-readable instructions to the client device 104 that causes the client device 104 to present the UI on a display of the client device 104. The set of machine-readable instructions may, for example, include presentation data (e.g., representing the UI) and a set of instructions to display the presentation data. The client device 104 may temporarily store the presentation data to enable display of the UI.

The UIs provided by the interface module 300 may include various maps, graphs, tables, charts, and other graphics used, for example, to provide information related to parking space occupancy and parking policy violations. The interfaces may also include various input control elements (e.g., sliders, buttons, drop-down menus, check-boxes, and data entry fields) that allow users to specify various inputs, and the interface module 300 receives and processes user input received through such input control elements.

The data intake module 302 is responsible for obtaining data transmitted from the camera node 106 to the parking policy management system 102. For example, the data intake module 302 may receive parking metadata (e.g., parking metadata 126) from the camera node 106. The parking metadata may, for example, be transmitted by the camera node 106 using a messaging protocol and upon receipt, the data intake module 302 may add the parking metadata to a messaging queue (e.g., maintained in the data store 318) for subsequent processing. The data intake module 302 may persist the parking metadata to one or more data objects stored in the data store 318. For example, the data intake module 302 may modify a data object associated with the camera 116, the parking space 120, or the vehicle 122 to include the received parking metadata 126.

In some instances, multiple cameras (e.g., multiple instances of camera 116) may record an image (e.g., image 124) of the parking space 120 and the vehicle 122. In these instances, the data intake module 302 may analyze the metadata associated with each of the images to determine which image to use for processing. More specifically, the data intake module 302 analyzes parking metadata for multiple images, and based on a result of the analysis, the data intake module 302 selects a single instance of parking metadata (e.g., a single set of pixel coordinates) to persist in the data store 318 for association with the parking space 120 or the vehicle 122.

The data intake module 302 may be further configured to retrieve actual images recorded by the camera 116 of the camera node 106 (or other instances of these components) for use by the interface module 300 in generating presentation data that represents a UI. For example, upon determining that the vehicle 122 is in violation of a parking rule applicable to the parking space 120, the data intake module 302 may retrieve two images from the camera node 106: a first image corresponding to first parking metadata used to determine the vehicle 122 is parked in the parking space 120 and a second image corresponding to second parking metadata used to determine the vehicle 122 is in violation of the parking rule applicable to the parking space 120.

The policy creation module 304 is responsible for creating and modifying parking policies associated with parking zones. More specifically, the policy creation module 304 may be utilized to create or modify parking zone data objects that include information describing parking policies associated with a parking zone. In creating and modifying parking zone data objects, the policy creation module 304 works in conjunction with the interface module 300 to receive user specified information entered into various portions of the policy creation UI. For example, a user may specify a location of a parking zone (or a parking space within the parking zone) by tracing an outline of the location on a geospatial map included in a parking zone creating interface provided by the interface module 300. The policy creation module 304 may convert the user input (e.g., the traced outline) to a set of global coordinates (e.g., geospatial coordinates) based on the position of the outline on the geospatial map. The policy creation module 304 incorporates the user-entered information into a parking zone data object associated with a particular parking zone and persists (e.g., stores) the parking zone data object in the data store 318.

The unique vehicle identification module 306 is responsible for identifying unique vehicles shown in multiple images recorded by multiple cameras. In other words, the unique vehicle identification module 306 may determine that a first object shown in a first image is the same as a second object shown in a second image, and that both correspond to the same vehicle (e.g., vehicle 122). In determining the vehicle 122 is shown in both images, the unique vehicle identification module 306 accesses known information (e.g., from the data store 318) about the angle, height, and position of the first and second camera using unique camera identifiers included in metadata. Using the known information about the physical orientation of the first and second camera such as angle, height, and position of the first and second camera, the unique vehicle identification module 306 compares the locations of the objects (e.g., geographic locations represented by a set of global coordinates) to determine if the difference in location of the objects is below an allowable threshold. The allowable threshold may, for example, be based on an expected trajectory of a vehicle in the area of the first and second camera based on speed limits, traffic conditions, and other such factors. Based on the determined location difference being below the allowable threshold, the unique vehicle identification module 306 determines the object (e.g., vehicle) shown in the first image is also the object (e.g., vehicle) shown in the second image.

The coordinate translation module 308 is responsible for translating pixel coordinates (e.g., defining a location in the image space) to global coordinates (e.g., defining a geographic location in the real-world). As noted above, the camera node 106 transmits parking metadata 126 to the parking policy management system 102 that includes a set of pixel coordinates that define a location of an object (e.g., vehicle 122) within the image space. The coordinate translation module 308 is thus responsible for mapping the location of the object (e.g., vehicle 122) within the image space to a geographic location in the real world by converting the set of pixel coordinates to a set of global (e.g., geographic) coordinates. In converting pixel coordinates to global coordinates, the coordinate translation module 308 may use the known angle, height, and position of the camera that recorded the image (e.g., included in a data object associated with the camera and maintained in the data store 318) in conjunction with a homography matrix to determine the corresponding global coordinates. The coordinate translation module 308 may further persist each set of global coordinates to a data object associated with either the parking space 120 or vehicle 122, or both.

The occupancy engine 310 is responsible for determining occupancy status of parking spaces. The occupancy engine 310 may determine the occupancy status of parking spaces based on an analysis of parking metadata associated with images showing the parking space. The occupancy status refers to whether a parking space is occupied (e.g., a vehicle is parked in the parking space) or unoccupied (e.g., no vehicle is parked in the parking space). As an example, the occupancy engine 310 may analyze the parking metadata 126 to determine whether the parking space 120 is occupied by the vehicle 122.

In determining the occupancy status of the parking space 120, the occupancy engine 310 may invoke the functionality of the overlap module 312 and the motion module 314. The overlap module 312 is responsible for determining whether the location of an object shown in an image overlaps (e.g., covers) a parking space based on image data describing the image. For example, the overlap module 312 determines whether the location of the vehicle 122 overlaps the location of the parking space 120 based on the parking metadata 126. The overlap module 312 determines whether the object overlaps the parking space based on a comparison of a location of the object (e.g., as represented by or derived from the set of pixel coordinates of the object included in the parking metadata) and known location of the parking space (e.g., included in a data object associated with the parking space). In comparing the two locations, the overlap module 312 may utilize centroid logic 320 to compute an arithmetic mean of the locations of the object and the parking space represented by sets of coordinates (e.g., either global or pixel) defining the location of each.

The motion module 314 is responsible for determining whether an object (e.g., a vehicle) shown in images is in motion. The motion module 314 determines whether an object shown in an image is in motion by comparing locations of the object from parking metadata of multiple images. For example, the motion module 314 may compare a first set of pixel coordinates received from the camera node 106 corresponding to the location of the vehicle 122 in a first image with a second set of pixel coordinates received from the camera node 106 corresponding to the location of the object in a second image, and based on the resulting difference in location transgressing a configurable threshold, the motion module 314 determines that the vehicle 122 is in motion. The motion module 314 may also utilize the centroid logic 320 in comparing the sets of pixel locations to determine the difference in location of the vehicle 122 in the two images.

If the motion module 314 determines that the vehicle 122 is in motion, the motion module 314 adds the locations of the vehicle 122 (e.g., derived from the sets of pixel coordinates) to a data object associated with the vehicle 122 and flags the vehicle 122 for further monitoring. Furthermore, if the motion module 314 determines that the vehicle 122 is in motion, or if the overlap module 312 determines that the location of the vehicle 122 does not overlap the location of the parking space 120, the occupancy engine 310 determines that the occupancy status of the parking space 120 is “unoccupied.” If the motion module 314 determines that the vehicle 122 is stationary (e.g., not in motion) and the overlap module 312 determines the location of the vehicle 122 overlaps the location of the parking space 120, the occupancy engine 310 determines that the occupancy status of the parking space 120 is “occupied.”

The parking rules engine 316 is responsible for determining parking rule violations based on parking metadata. As an example, in response to the occupancy engine 310 determining that the parking space 120 is occupied by the vehicle 122, the parking rules engine 316 checks whether the vehicle 122 is in violation of a parking rule included in a parking policy associated with the parking space. In determining whether the vehicle 122 is in violation of a parking rule, the parking rules engine 316 accesses a parking zone data object associated with the parking zone in which the parking space is located. The parking zone data object includes the parking policy associated with the parking zone. The parking policy may include a set of parking rules that limit parking in the parking zone. Parking rules may be specifically associated with particular parking spaces and may have limited applicability to certain hours of the day, days of the week, or days of the year. Accordingly, in determining whether the vehicle 122 is in violation of a parking rule, the parking rules engine 316 determines which parking rules from the parking policy are applicable based on comparing a current time with timing attributes associated with each parking rule. Some parking rules may place a time limit on parking in the parking space 120, and thus, the parking rules engine 316 may determine whether the vehicle 122 is in violation of a parking rule based on an elapsed time of the vehicle 122 being parked in the parking space 120 exceeding the time limit imposed by one or more parking rules.

The data store 318 stores data objects pertaining to various aspects and functions of the parking policy management system 102. For example, the data store 318 may store: camera data objects including information about cameras such as a camera identifier, and orientation information such as angles, height, and position of the camera; parking zone data objects including information about known geospatial locations (e.g., represented by global coordinates) of parking spaces in the parking zone, known locations of parking spaces within images recorded by cameras in the parking zone (e.g., represented by pixel coordinates), and parking policies applicable to the parking zone; and vehicle data objects including an identifier of the vehicle, locations of the vehicle, images of the vehicle, and records of parking policy violations of the vehicle. Within the data store 318, camera data objects may be associated with parking zone data objects so as to maintain a linkage between parking zones and the cameras that record images of parking spaces and vehicles in the parking zone. Further, vehicle data objects may be associated with parking zone data objects so as to maintain a linkage between parking zones and the vehicles parked in a parking space in the parking zone. Similarly, camera data objects may be associated with vehicle data objects so as to maintain a linkage between cameras and the vehicles shown in images recorded by the cameras.

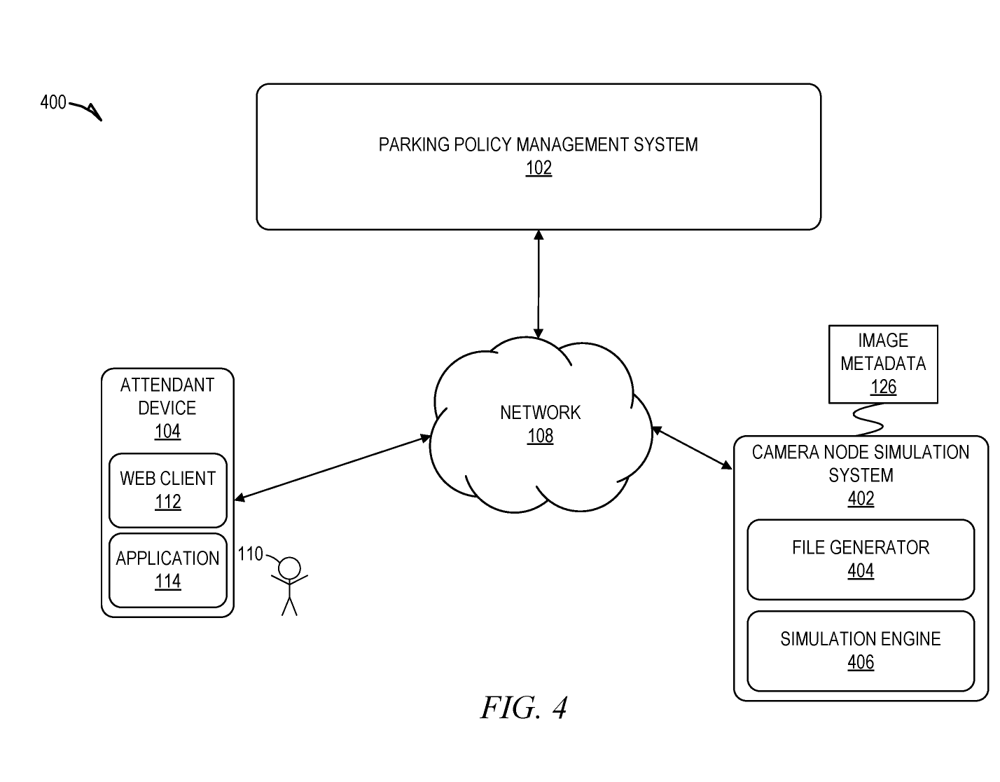

FIG. 4 is an architecture diagram showing a network system 400 having a client-server architecture configured for monitoring parking policy violations using simulated camera node output data, according to some embodiments. While the network system 400 shown in FIG. 4 may employ a client-server architecture, the present inventive subject matter is, of course, not limited to such an architecture, and could equally well find application in an event-driven, distributed, or peer-to-peer architecture system, for example. Moreover, it shall be appreciated that although the various functional components of the network system 400 are discussed in the singular sense, multiple instances of one or more of the various functional components may be employed.

The network system 400 is similar to the network system 100 in that it includes the parking policy management system 102 and the client device 104. However, contrary to the network system 100, the network system 400 includes a camera node simulation system 402 in lieu of the camera node 106. The camera node simulation system 402 is responsible for generating and providing data to simulate the output of the camera node 106. In other words, the camera node simulation system 402 may generate and provide the parking metadata 126 so as to simulate the output of the camera node 106. As shown, the parking policy management system 102, the client device 104, and the camera node simulation system 402 are all communicatively coupled to each other via the network 108.

The camera node simulation system 402 may be implemented in a special-purpose (e.g., specialized) computer system, in whole or in part, as described below. As shown, the camera node simulation system 402 includes a file generator 404 and a simulation engine 406. The file generator 404 and the simulation engine 406 may be implemented using hardware (e.g., a processor of a machine) or a combination of hardware and software. For example, either one of the file generator 404 or the simulation engine 406 may configure a processor to perform the operations described herein for that module. Moreover, the file generator 404 and the simulation engine 406 may, in some embodiments, be combined into a single component (e.g., module), and the functions described herein for either the file generator 404 or the simulation engine 406 may be subdivided among multiple components. Furthermore, according to various example embodiments, either one of the file generator 404 or simulation engine 406 may be implemented together or separately within a single machine, database, or device may be distributed across multiple machines, databases, or devices.

The file generator 404 is responsible for generating a camera node output simulation file to that mimics the output (e.g., parking metadata 126) of instances of the camera node 106. The data may, for example, include a camera node identifier, a camera identifier, an object identifier, a timestamp, and pixel coordinates defining a location of the object (e.g., a parked vehicle) in an image.

The simulation engine 406 takes the simulation file as its primary input along with an identifier of the parking policy management system 102 (e.g., a URI) where simulation data is sent for testing. The simulation engine 406 may then use the camera node simulation file to transmit data packets including the simulated output data to the parking policy management system 102 where, for example, in-memory processing may determine if a parking space is occupied and if there is a parking violation. For example, the parking policy management system 102 may uses the pixel coordinates included in the simulated output data (e.g., parking metadata 126) to determine whether a vehicle is occupying (e.g., parked in) a parking space.

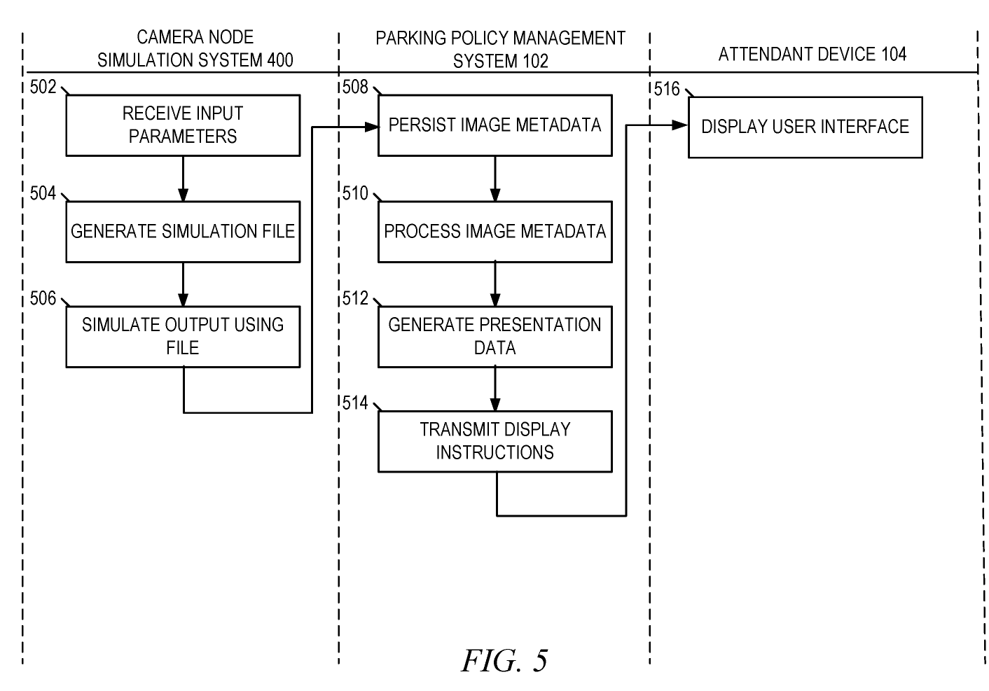

FIG. 5 is an interaction diagram illustrating example interactions between components of the network system illustrated in FIG. 4, according to some embodiments. In particular, FIG. 5 illustrates example interactions that occur between the parking policy management system 102, client device 104, and the camera node simulation system 402 as part of testing the ability of the parking policy management system 102 to monitor parking policy violations in a parking zone.

At operation 502, the camera node simulation system 402 receives input parameters related to the simulation of the output of a set of camera nodes (e.g., a set of the camera node 106). The input parameters may, for example, include: an object parameter specifying a number of objects (e.g., vehicles) to include in the simulated data; a camera node parameter specifying a number of camera nodes to include in the simulated data; location parameters specifying an initial (e.g., starting) location and a final (e.g., ending) location; a loop parameter specifying a number of times to loop through the camera node simulation output file in simulating camera node output; and an interval time specifying a time interval for sending data packets that include simulated parking metadata. The object, camera node, and location parameters may be used by the file generator 404 in generating the camera node simulation file while the loop and time interval parameters may be used by the simulation engine 406. Values for each of the input parameters may be default values set by an administrator of the parking policy management system 102, or may be received from the client device 104 (e.g., as a submission from the user 110 or a preference of the user 110).

At operation 504, the file generator 404 of the camera node simulation system 402 generates a camera node simulation data file based on the input parameters. In particular, the file generator 404 generates the camera node simulation data file to include simulated output data (e.g., parking metadata 126) for the number of camera nodes specified by the camera node parameter. The camera node simulation data file further includes the number of objects specified by the object parameter. The camera node simulation data file includes multiple entries. Each entry corresponds to a single output of a single camera node (e.g., the camera node 106) and includes a camera node identifier, a camera identifier, an object identifier (e.g., an identifier of a vehicle), a timestamp, and pixel coordinates for the object (e.g., a parked vehicle).

At operation 506, the simulation engine 406 simulates camera node output using the camera node output simulation file. In simulating the camera node output, the simulation engine 406 sequentially reads entries from the camera node simulation data file, generates a data packet encompassing each entry, and transmits the data packet to the parking policy management system 102 using a standard messaging protocol. Accordingly, each data packet transmitted by the camera node simulation system 402 includes the simulated parking metadata. Each data packet thusly includes pixel coordinates of the object (e.g., the vehicle 122) along with a timestamp (e.g., a date and time the image was recorded), a camera identifier (e.g., identifying the camera 116), a camera node identifier (e.g., identifying the camera node 106 or a location of the camera node 106), and an object identifier (e.g., a unique identifier assigned to the vehicle 122). The simulation engine 406 periodically transmits the data packets at the time interval specified by the time interval parameter. Additionally, the simulation engine 406 may iterate through the camera node output simulation file multiple different times based on the value of the loop parameter. In other words, upon reading the final entry of the camera node output data file and transmitting a data packet representing the final entry, the simulation engine 406 may return to the initial entry of the camera node output data file and repeatedly perform the entire process until the simulation engine 406 has looped through the camera node output data file the number of times specified by the loop parameter.

At operation 508, the parking policy management system 102 persists (e.g. saves) the simulated parking metadata included in each data packet to a data store (e.g., a database). In persisting the simulated parking metadata to the data store, the parking policy management system 102 may create or modify a data object associated with the corresponding camera node or parking space. The created or modified data object includes the received parking metadata. As the camera node simulation system 402 continues to transmit subsequent parking metadata, the parking policy management system 102 may store the subsequent parking metadata in the same data object or in another data object that is linked to the same data object. In this way, the parking policy management system 102 maintains a log of parking activity. It shall be appreciated that since the camera node simulation system 402 may simulate data output by multiple camera nodes, the parking policy management system 102 may accordingly maintain separate records for each camera node so as to maintain a log of parking activity with respect to different parking spaces.

At operation 510, the parking policy management system 102 processes the parking metadata received from the camera node simulation system 402. As discussed above, the processing of the parking metadata may, for example, include determining an occupancy status of a parking space or determining whether a vehicle is in violation of a parking rule applicable to the parking space.

At operation 512, the parking policy management system 102 generates presentation data corresponding to a user interface. The presentation data may include a geospatial map of the area surrounding the parking space 120, visual indicators of parking space occupancy, visual indicators of parking rule violations, visual indicators of locations visited by vehicles, identifiers of specific parking rules being violated, images of the vehicles, and textual information describing the vehicles (e.g., make, model, color, and license plate number). The UI may include the geospatial map overlaid with visual indicators of parking space occupancy and parking rule violations that may be selectable (e.g., through appropriate user input device interaction with the UI) to present additional UI elements that include the images of vehicles and textual information describing the vehicle.

At operation 514, the parking policy management system 102 transmits the presentation data to the client device 104 to cause the client device 104 to present the UI on a display of the client device 104. Upon receiving the presentation data, the client device 104 may temporarily store the presentation data to enable the client device to display the UI, at operation 516.

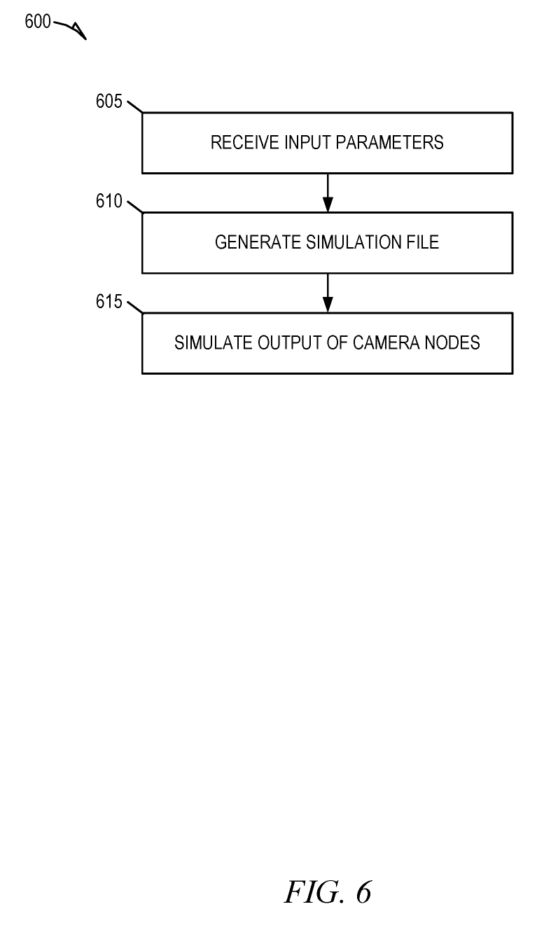

FIG. 6 is a flowchart illustrating a method 600 for providing simulated camera node output data, according to some embodiments. The method 600 may be embodied in computer-readable instructions for execution by one or more processors such that the operations of the method 600 may be performed in part or in whole by the camera node simulation system 402; accordingly, the method 600 is described below by way of example with reference thereto. However, it shall be appreciated that at least some of the operations of the method 600 may be deployed on various other hardware configurations and the method 600 is not intended to be limited to the camera node simulation system 402.

At operation 602, the camera node simulation system 402 receives input parameters for simulating camera node output data of a set of camera nodes (e.g., a set of the camera nodes 106). The input parameters may, for example, include: an object parameter specifying a number of objects (e.g., vehicles) to include in the simulated data; a camera parameter specifying a number of cameras to include in the simulated data; a camera node parameter specifying a number of camera nodes to include in the simulated data; location parameters specifying an initial (e.g., starting) location and a final (e.g., ending) location; a loop parameter specifying a number of times to loop through the camera node simulation output file in simulating camera node output; and an interval time specifying a time interval for sending data packets that include simulated parking metadata. Accordingly, the receiving of the input parameters may include: receiving an object parameter value specifying a number of objects (e.g., vehicles) to include in the simulated data; receiving a camera node parameter value specifying a number of camera nodes to include in the simulated data; receiving a camera parameter value specifying a number of cameras to include in the simulated data; receiving location data specifying an initial (e.g., starting) location and a final (e.g., ending) location; receiving a loop parameter specifying a number of times to loop through the camera node simulation output file in simulating camera node output; and receiving an interval time specifying a time interval for sending data packets that include simulated parking metadata.

At operation 610, the file generator 404 generates a camera node output simulation file that mimics the output of the set of camera nodes. The camera node simulation file includes multiple entries, and each entry represents metadata of an image recorded by a camera node. Each entry includes a camera node identifier (e.g., identifying a camera node), a camera identifier (e.g., identifying a camera), an object identifier (e.g., identifying an object), a set of pixel coordinates (e.g., a coordinate pair of each corner of the object) defining a location of the object in the image, and a timestamp (e.g., representing the time at which the image was recorded).

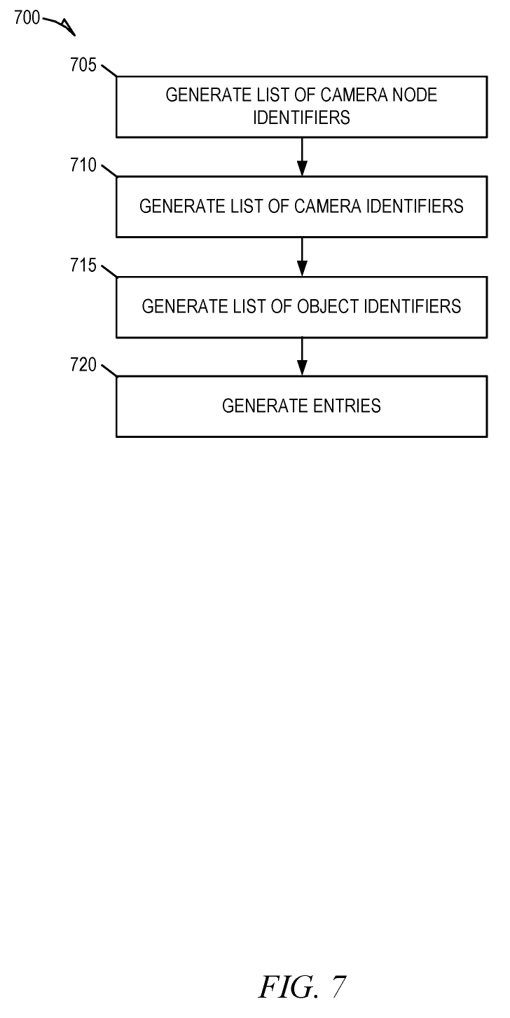

The file generator 404 generates the camera node output simulation file based on a portion of the received input parameters. For example, the file generator 404 may generate the camera node output simulation file to include entries for the number of camera nodes specified by the camera node parameter value. Further, the file generator 404 generates the camera node output simulation file to include pixel coordinates for the number of objects specified by the object parameter value. Further details regarding the generation of the camera node output simulation file are discussed below in reference to FIG. 7, consistent with some embodiments.

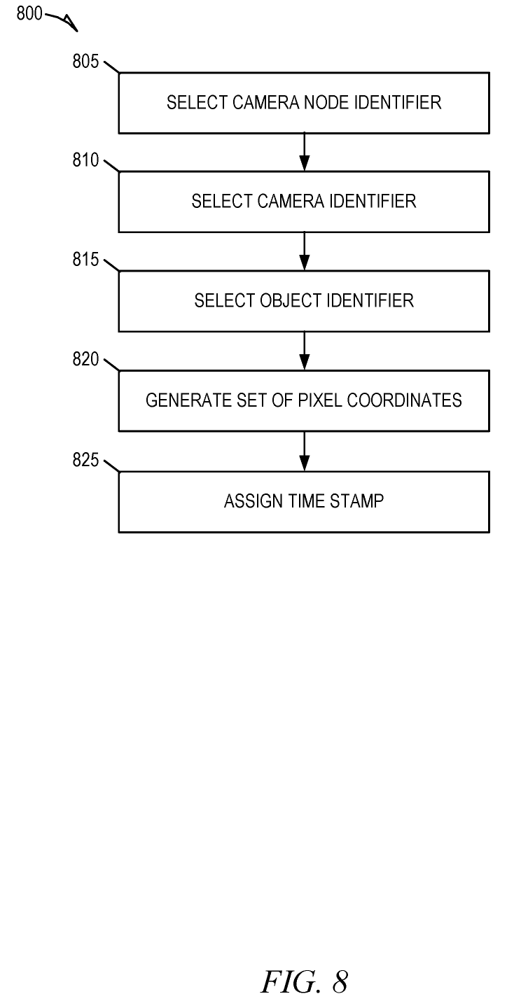

At operation 615, the simulation engine 406 simulates the output of the set of camera nodes using the camera node output simulation file. In simulating the output of the set of camera nodes, the simulation engine 406 continuously streams data packets to the parking policy management system 102 that include simulated parking metadata from entries read sequentially (e.g., according to a chronological ordered defined by timestamps of individual time stamps) from the camera node output simulation file. Each data packet may be formatted according to a messaging protocol. The simulation engine 406 may periodically transmit the data packets at a time interval specified by the time interval parameter. Further, the simulation engine 406 may loop through the camera node output simulation file (e.g., read entries and transmit data packets including the data read from the entry) a number of times based on the loop parameter value. Further details regarding the simulation of the output of the set of camera nodes are discussed below in reference to FIG. 8, consistent with some embodiments.

FIG. 7 is a flowchart illustrating a method 700 for generating a camera node output simulation file, according to some embodiments. The method 700 may be embodied in computer-readable instructions for execution by one or more processors such that the operations of the method 700 may be performed in part or in whole by the camera node simulation system 402; accordingly, the method 700 is described below by way of example with reference thereto. However, it shall be appreciated that at least some of the operations of the method 700 may be deployed on various other hardware configurations and the method 700 is not intended to be limited to the camera node simulation system 402. In some example embodiments, the method 700 may be performed as part (e.g., a precursor task, a subroutine, or a portion) of operation 605 of method 600, in which the file generator 404 generates the camera node output simulation file.

At operation 705, the file generator 404 generates a list of camera node identifiers. The number of camera node identifiers included in the list generated by the file generator 404 is based on a camera node parameter value received as part of the input parameters. In some embodiments, the file generator 404 may generate the list of camera node identifiers by retrieving a list of camera node identifiers (e.g., from the data store 318) associated with a location defined by the location data received as an input parameter (e.g., camera node identifiers corresponding to camera nodes that record images in the location). In some embodiments, the file generator 404 may randomly generate camera node identifiers for inclusion in the list of camera node identifiers.

At operation 710, the file generator 404 generates a list of camera identifiers. The number of camera identifiers included in the list generated by the file generator 404 is based on camera parameter value received as part of the input parameters. In some embodiments, the file generator 404 may generate the list of camera identifiers by retrieving a list a camera identifiers (e.g., from the data store 318) associated with the list of camera node identifiers (e.g., camera identifiers corresponding to cameras included in each of the identified camera nodes). In some embodiments, the file generator 404 may randomly generate camera identifiers for inclusion in the list of camera identifiers.

At operation 715, the file generator 404 generates a list of object identifiers. The number of object identifiers included in the list generated by the file generator 404 is based on the object parameter value received as part of the input parameters. The file generator 404 may randomly generate object identifiers for inclusion in the list of camera identifiers.

At operation 720, the file generator 404 generates a plurality of entries for the camera node output simulation file using the list of camera node identifiers, camera identifiers, and object identifiers. Each entry includes a camera node identifier, a camera identifier, an object identifier, a set of pixel coordinates, and a time stamp. The camera node output simulation file generated by the file generator includes at least one entry for each camera node identifier, camera identifier, and object identifier. Further details regarding the generation of individual entries are discussed below in reference to FIG. 8, consistent with some embodiments.

FIG. 8 is a flowchart illustrating a method 800 for generating an entry in the camera node output simulation file, according to some embodiments. The method 800 may be embodied in computer-readable instructions for execution by one or more processors such that the operations of the method 800 may be performed in part or in whole by the camera node simulation system 402; accordingly, the method 800 is described below by way of example with reference thereto. However, it shall be appreciated that at least some of the operations of the method 800 may be deployed on various other hardware configurations and the method 800 is not intended to be limited to the camera node simulation system 402. In some example embodiments, the method 800 may be performed as part (e.g., a precursor task, a subroutine, or a portion) of operation 720 of method 700, in which the file generator 404 generates the camera node output simulation file.

At operation 805, the file generator 404 selects a camera node identifier from the list of camera node identifiers for inclusion in the entry. At operation 810, the file generator 404 selects a camera identifier from the list of camera identifiers for inclusion in the entry. At operation 815, the file generator 404 selects an object identifier from the list of object identifiers for inclusion in the entry.

At operation 820, the file generator 404 generates a set of pixel coordinates for inclusion in the entry. The set of pixel coordinates represent a location of the identified object within an image. The file generator 404 generates a coordinate pair (e.g., an X-axis value and a Y-axis value) for each corner in the object. In some embodiments, the object represents a vehicle, and as such, the file generator 404 generates a set of pixel coordinates having four coordinate pairs—one for each corner of the vehicle.

At operation 825, the file generator 404 assigns a time stamp to the entry. The time stamp represents a time at which the image was recorded. In some embodiments, the file generator 404 may utilize the current time in generating a time stamp. In some embodiments, the file generator 404 may use an initial time for a first time stamp of the first entry, and may increment each subsequent time stamp by the interval time specified by the interval time parameter value.

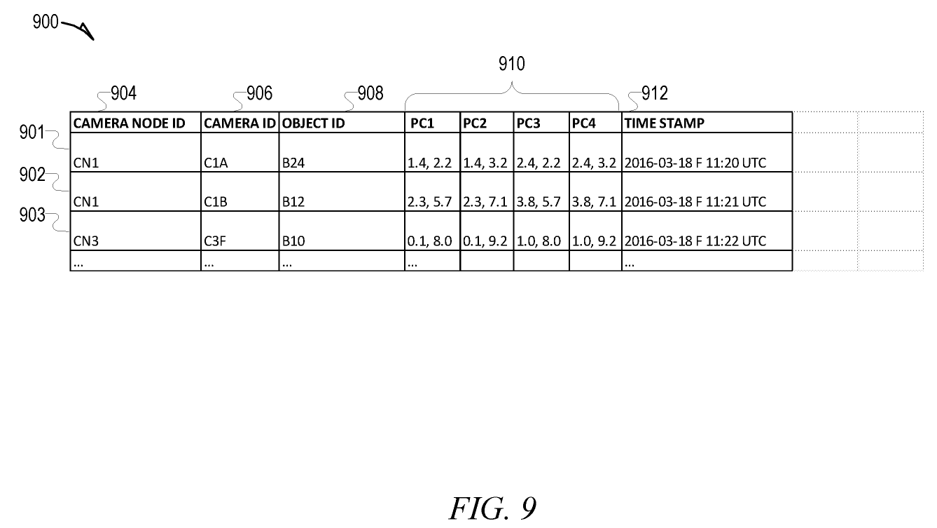

FIG. 9 is a conceptual diagram illustrating a portion of a camera node output simulation file 900, according to some embodiments. As shown, the camera node output simulation file 900 includes entries 901-903. Each of the entries 901-903 include a camera node identifier 904, a camera identifier 906, an object identifier 908, a set of pixel coordinates 910 (e.g., a coordinate pair for each corner of the object), and a timestamp 912. The camera node output simulation file 900 is a time series file ordered chronologically by time stamp (e.g., earliest time stamp to latest time stamp).

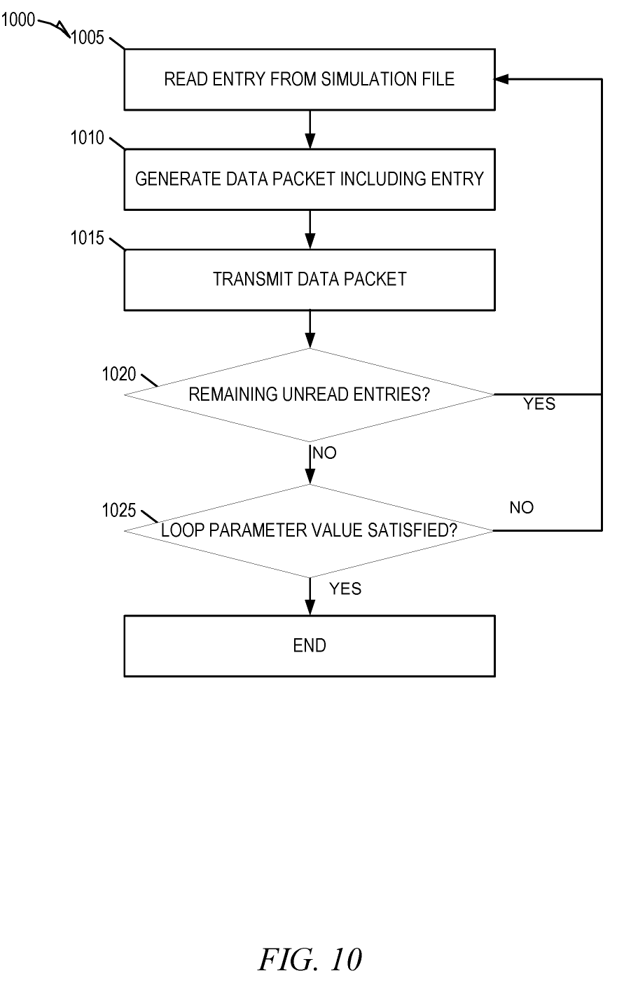

FIG. 10 is a flowchart illustrating a method 1000 for simulating camera node output, according to some embodiments. The method 1000 may be embodied in computer-readable instructions for execution by one or more processors such that the operations of the method 1000 may be performed in part or in whole by the camera node simulation system 402; accordingly, the method 1000 is described below by way of example with reference thereto. However, it shall be appreciated that at least some of the operations of the method 1000 may be deployed on various other hardware configurations and the method 1000 is not intended to be limited to the camera node simulation system 402.

At operation 1005, the simulation engine 406 reads an entry from the camera node output simulation file. The simulation engine 406 reads entries sequentially from the camera node output simulation file in a chronological order defined by the time stamps of each entry. For example, initially, the simulation engine 406 may read the initial entry in the camera node output simulation file (e.g., the entry with the earliest time stamp), and in the subsequent iteration of the operation 1005, the simulation engine 404 reads the next entry in the sequence according to the chronological ordering of the entries defined by respective time stamps (e.g., the entry with the second earliest time stamp). Using the camera node output simulation file 900 as an example, the simulation engine 406 initially reads the entry 901, and on the next iteration the simulation engine 406 reads the entry 902, and on the next iteration the simulation engine 406 reads the entry 903.

At operation 1010, the simulation engine 406 generates a data packet that includes simulated parking metadata (e.g., a camera node identifier, a camera identifier, an object identifier, a set of pixel coordinates, and a time stamp) read from the entry in the camera node simulation output file. The generating of the data packet may include formatting the parking metadata from the entry according to a messaging protocol. The data packet generated by the simulation engine 406 further includes a location identifier (e.g., a URI) of the parking policy management system 102.

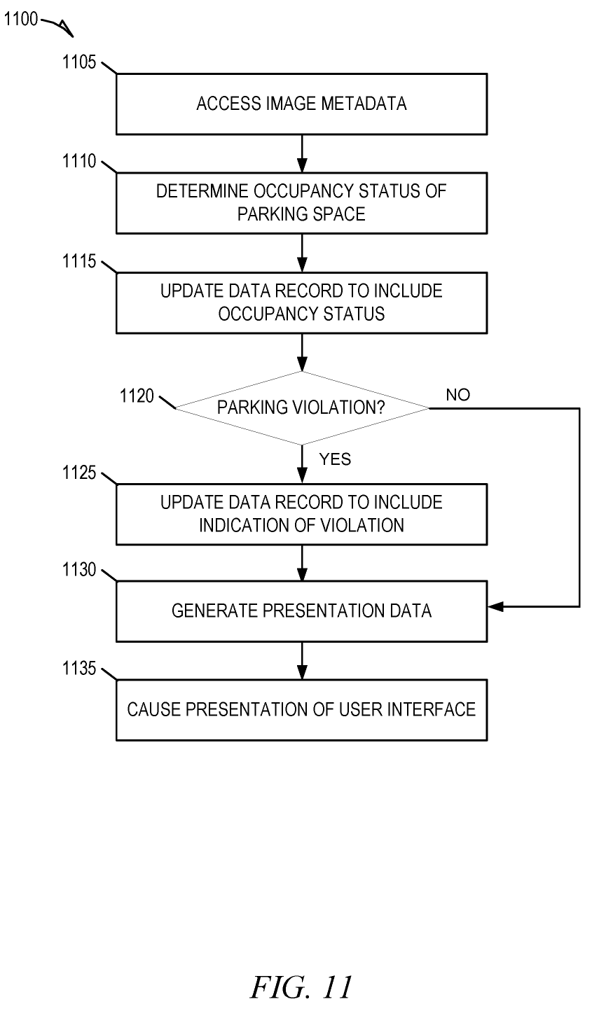

At operation 1015, the simulation engine 406 transmits the data packet to the parking policy management system 102. The simulation engine 406 may transmit the data packet using a messaging protocol. Upon receiving the data packet, the parking policy management system 102 may add the data packet to a messaging queue for subsequent processing. An example of the processing performed by the parking policy management system 102 is discussed below in reference to FIG. 11, consistent with some embodiments.

At decision block 1020, the simulation engine 406 determines whether there are any remaining unread entries in the camera node simulation output file. If, at decision block 1020, the simulation engine 406 determines there are remaining unread entries, the method returns to operation 1005 where the next entry is read from the camera node output simulation file. If, at decision block 1020, the simulation engine 406 determines there are no remaining unread entries (e.g., the final entry has been read), the method continues to decision block 1025.

At decision block 1025, the simulation engine 406 determines whether the loop parameter value has been satisfied. In other words, the simulation engine 406 determines whether it has looped through the camera node simulation output file the number of times specified by the loop parameter value. The simulation engine 406 may track the number of loops by incrementing a loop counter each time the final entry in the camera node simulation output file has been read, and the simulation engine 406 may determine the outcome of decision block 1025 based on a comparison of the loop counter to the loop parameter value. If at decision block 1025, the simulation engine 406 determines the loop parameter value has not been satisfied, the method 1000 returns to operation 1005 where the initial entry is read from the camera node output simulation file. If at decision block 1025, the simulation engine 406 determines the loop parameter value has been satisfied, the method 1000 ends.

FIG. 11 is a flowchart illustrating a method 1100 for monitoring parking policy violations, according to some embodiments. The method 1100 may be embodied in computer-readable instructions for execution by one or more processors such that the operations of the method 1100 may be performed in part or in whole by the parking policy management system 102; accordingly, the method 1100 is described below by way of example with reference thereto. However, it shall be appreciated that at least some of the operations of the method 1100 may be deployed on various other hardware configurations and the method 1100 is not intended to be limited to the parking policy management system 102.

At operation 1105, occupancy engine 310 accesses parking metadata associated with an image recorded by a camera node. The parking metadata includes a set of pixel coordinates describing a location of an object in the image. The set of coordinates include a coordinate pair (e.g., an X-axis value and a Y-axis value) that define a location of each corner of the object. The parking metadata may further include a timestamp (e.g., a date and time the image was recorded), a camera identifier (e.g., identifying the camera 116), a location identifier (e.g., identifying the camera node 106 or a location of the camera node 106), and an object identifier (e.g., a unique identifier assigned to the vehicle 122). As an example, the object shown in the image may correspond to the vehicle 122, though application of the methodologies described herein is not necessarily limited to vehicles and may find application in other contexts such with monitoring trash or other parking obstructions.

At operation 1110, the occupancy engine 310 determines an occupancy status of a parking space (e.g., the parking space 120) shown in the image based on the pixel coordinates of the object (e.g., vehicle 122) included in the metadata associated with the image. The occupancy status of a parking space indicates whether a vehicle is parked in the parking space. Accordingly, in determining the occupancy status of the parking space, the occupancy engine 310 determines whether a vehicle is parked in the parking space. The occupancy engine 310 may determine the occupancy status of the parking space based on a comparison of the real-world location of the object (e.g., vehicle 122) to a known location (e.g., in the real-world) of the parking space (e.g., accessed from a location look-up table accessed from the data store 318). The location of the object (e.g., vehicle 122) may be derived from the pixel coordinates and a known location of the camera node.

At operation 1115, the occupancy engine 310 updates one or more data objects (e.g., maintained in the data store 318) to reflect the occupancy status of the parking space. In some embodiments, the updating of the one or more data objects includes updating a field in a data object corresponding to the parking space to reflect that the parking space is either occupied (e.g., a vehicle is parked in the parking space 120) or unoccupied (e.g., a vehicle is not parked in the parking space 120). In some embodiments, the updating of the one or more data objects includes: updating a first field in a data object corresponding to the vehicle to include an indication of whether the vehicle is parked or in motion and updating a second field in the data object corresponding to the vehicle to include the location of the vehicle at a time corresponding to a timestamp of the image (e.g., included in the metadata of the image).

In response to the occupancy engine 310 determining the vehicle is parked in the parking space, the parking rules engine 316 determines whether the vehicle is in violation of a parking rule included in a parking policy associated with (e.g., applicable to) the parking space 120, at decision block 1120. In determining whether the vehicle is in violation of a parking policy, the parking engine accesses a data object (e.g., a table) from the data store 318 that includes a parking policy applicable to the parking space. The parking policy may include one or more parking rules that impose a constraint (e.g., a time limit) on parking in the parking space. Certain parking rules may be associated with certain times or dates. Accordingly, the determining of whether the vehicle is in violation of a parking rule includes determining which parking rules of the parking policy are applicable to the vehicle, which, may, in some instances, be based on the timestamp of the image (e.g., included in the parking metadata).

In instances in which an applicable parking rule includes a time limit on parking in the parking space, the parking rules engine 316 may monitor the parking metadata received from the camera showing the parking space and the vehicle to determine an elapsed time associated with the occupancy of the parking space by the vehicle. The parking rules engine 316 may determine the elapsed time of the occupancy of the parking space based on a comparison of a first timestamp included in parking metadata from which the vehicle was determined to be parked in the parking space, and a second timestamp included in the metadata being analyzed. Once the parking rules engine 316 determines the elapsed time associated with the occupancy of the parking space, the parking rules engine 316 determines whether the elapsed time exceeds the time limit imposed by the parking rule.

If, at decision block 1120, the parking rules engine 316 determines the vehicle is in violation of a parking rule included in the parking policy associated with the parking space, the method continues to operation 1025 where the parking rules engine 316 updates a data object (e.g., stored and maintained in the data store 318) associated with the vehicle to reflect the parking rule violation. The updating of the data object may include augmenting the data object to include an indication of the parking rule violation (e.g., setting a flag corresponding to a parking rule violation). The updating of the data object may further include augmenting the data object to include an identifier of the parking rule being violated.

At operation 1130, the interface module 300 generates presentation data representing a UI (e.g., a parking attendant interface) for monitoring parking space occupancy and parking rules violations in a parking area that includes the parking space. The presentation data may include images, a geospatial map of the area surrounding the parking space, visual indicators of parking space occupancy (e.g., based on information included in data objects associated with the parking spaces), visual indicators of parking rule violations (e.g., based on information included in data objects associated with the parking spaces), identifiers of specific parking rules being violated, images of the vehicle, and textual information describing the vehicle (e.g., make, model, color, and license plate number). Accordingly, in generating the presentation data, the parking policy management system 102 may retrieve, from the camera node 106, a first image corresponding to a first timestamp included in parking metadata from which the vehicle was determined to be parked in the parking space, and a second image corresponding to the parking metadata from which the parking policy monitoring system determined that the vehicle is in violation of the parking rule.

At operation 1135, the interface module 300 causes presentation of the UI on the client device 104. In causing presentation of the UI, the interface module 300 may transmit the presentation data to the client device 104 to cause the client device 104 to present the UI on a display of the client device 104. Upon receiving the presentation data, the client device 104 may temporarily store the presentation data to enable the client device to display the UI.

The UI may include the geospatial map overlaid with visual indicators of parking space occupancy and parking rule violations that may be selectable (e.g., through appropriate user input device interaction with the UI) to presented additional UI elements that include the images of the vehicle 122 and textual information describing the vehicle.

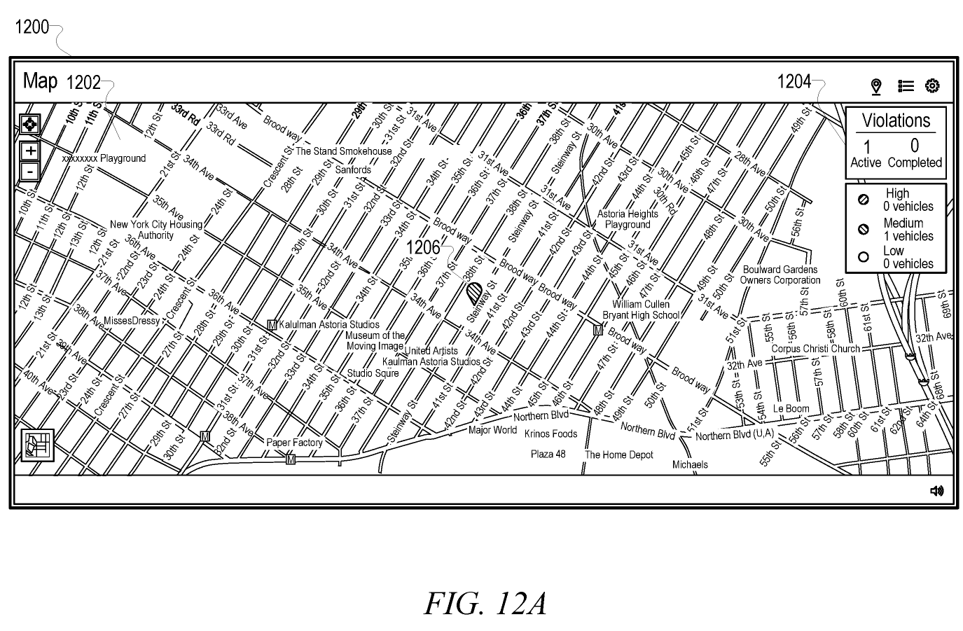

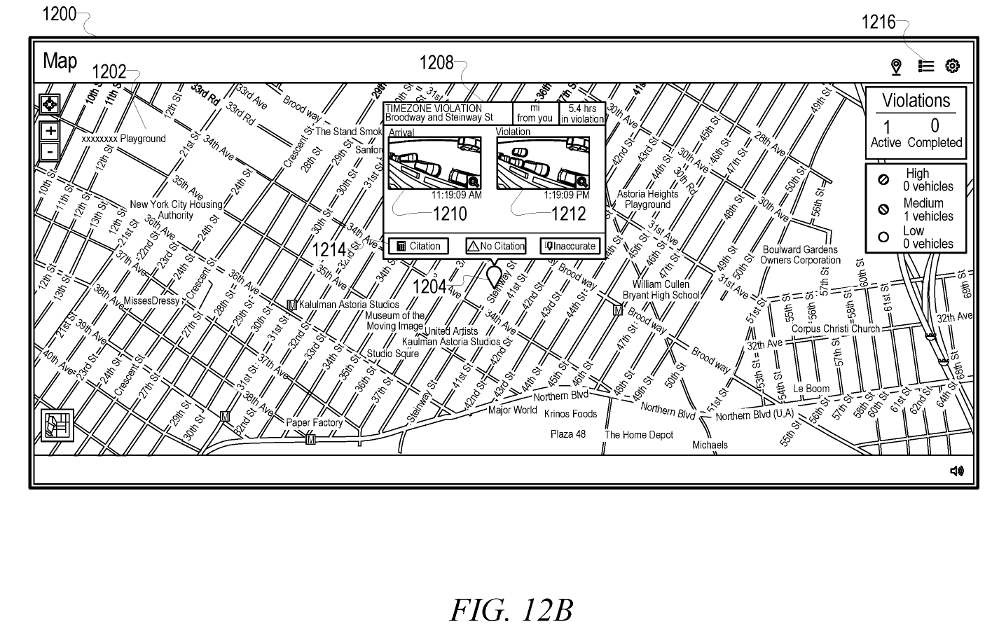

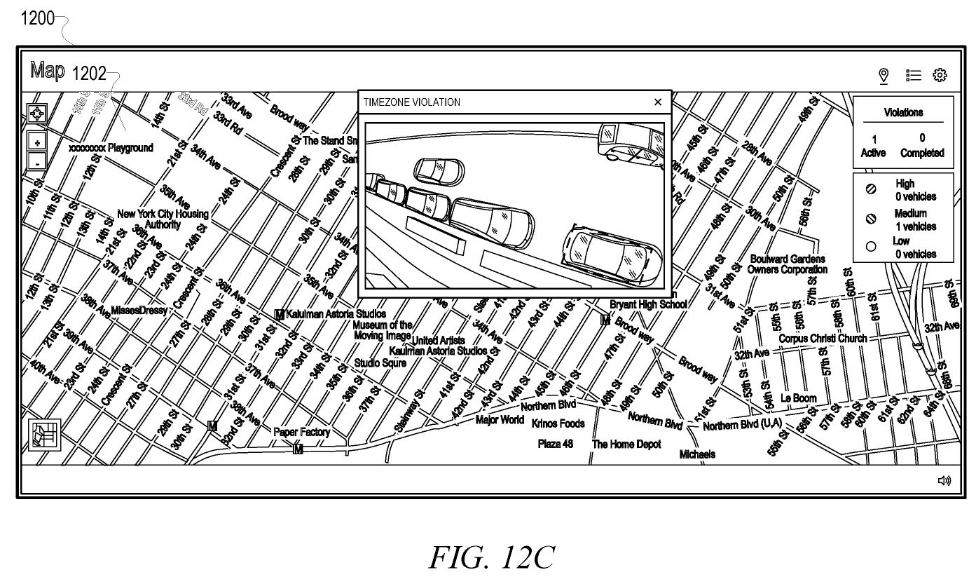

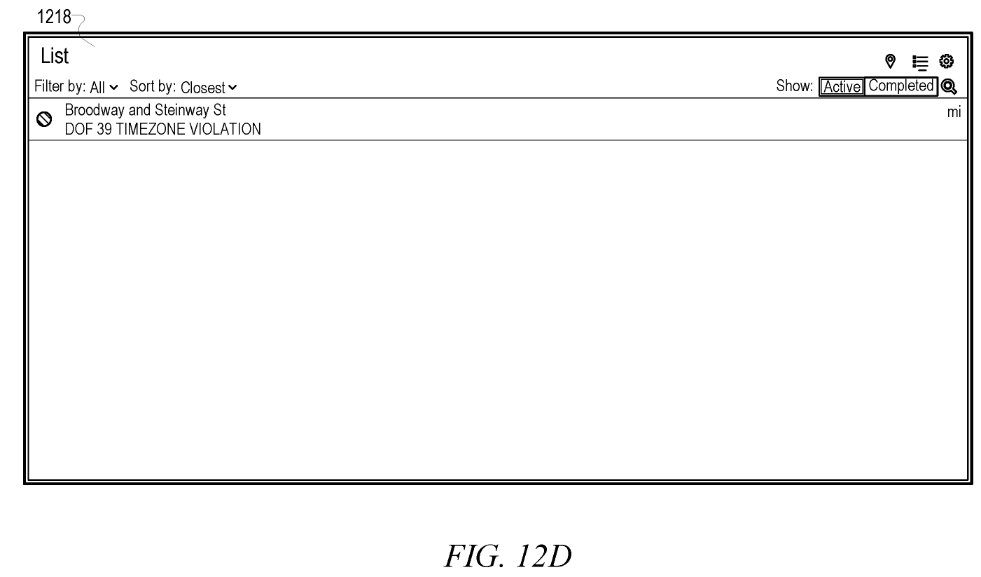

FIGS. 12A-12D are interface diagrams illustrating portions of an example UI 1200 for monitoring parking rule violations in a parking zone, according to some embodiments. The UI 1200 may, for example, be presented on the client device 104, and may enable a parking attendant (or other parking policy enforcement personnel) to monitor parking policy violations in real-time. As shown, the UI 1200 includes a geospatial map 1202 of a particular area of a municipality. In some embodiments, the parking policy management system 102 may generate the UI 1 to focus specifically of the area of the municipality assigned to the parking attendant user of the client device 104, while in other embodiments, the parking attendant user may interact with the UI 1200 (e.g., through appropriate user input) to select and focus on the area to which they are assigned to monitor.

The UI 1200 further includes overview element 1204 that includes an overview of the parking violations in the area. For example, the overview element 1204 includes a total number of active violations and a total number of completed violations (e.g., violations for which a citation has been given). The overview element 1204 also includes breakdown of violations by priority (e.g., “High,” “Medium,” and “Low”).

The UI 1200 also includes indicators of locations of parking rule violations. For example, the UI 1200 includes a pin 1206 that indicates that a vehicle is currently in violation of a parking rule at the location of the pin 1206. Each violation indicator may be adapted to include visual indicators (e.g., colors or shapes) of the priority of the parking rule violation (e.g., “High,” “Medium,” and “Low”). Additionally, the indicators may be selectable (e.g., through appropriate user input by the user 130) to present further details regarding the parking rule being violated.

For example, upon receiving selection of the pin 1206, the user interface module 300 updates the UI 1200 to include window 1208 for presenting a description of the parking rule being violated, an address of the location of the violation, a time period in which the vehicle has been in violation, images 1210 and 1212 of the vehicle, and a distance from the current location of the parking attendant and the location of the parking rule violation (e.g., as determined by location information received from the client device 104 and the set of global coordinates corresponding to the determined parking policy violation). The window 1208 also includes a button 1214 that when selected by the user 110 causes the parking policy management system 102 to automatically issue and provide (e.g., mailed or electronically transmitted) a citation (e.g., a ticket) to an owner or responsible party of the corresponding vehicle.

Each of the images 1210 and 1212 include a timestamp corresponding to the time at which the images were recorded. The image 1210 corresponds to the first image from which the parking policy management system 102 determined the vehicle was parked in the parking space, and the image 1212 corresponds to the first image from which the parking policy management system 102 determined the vehicle was in violation of the parking rule. As noted above, the parking policy management system 102 determines that the vehicle is parked in the parking space and that the vehicle is in violation of the parking rule from the metadata associated with the images, rather than from the images themselves. Upon determining the vehicle is in violation of the parking rule, the parking policy management system 102 retrieves the images 1210 and 1212 from the camera node that recorded the images (e.g., an instance of the camera node 106).

The user 110 may select either image 1210 or 1212 (e.g., using a mouse) for a larger view of the image. For example, FIG. 12C illustrates a larger view of the image 1212 presented in response to selection of the image 1212 from the window 1208. As shown, in the larger view, the image 1212 includes a visual indicator (e.g., an outline) of the parking space in which the vehicle is parked.

Returning to FIG. 12B, the user 110 may access a list view of the violations through selection of icon 1216. As an example, FIG. 12D illustrates a list view 1218 of violation in the area. As shown, the violation is identified by location (e.g., address) and the list view includes further information regarding the parking rule being violation (e.g., “TIMEZONE VIOLATION”).

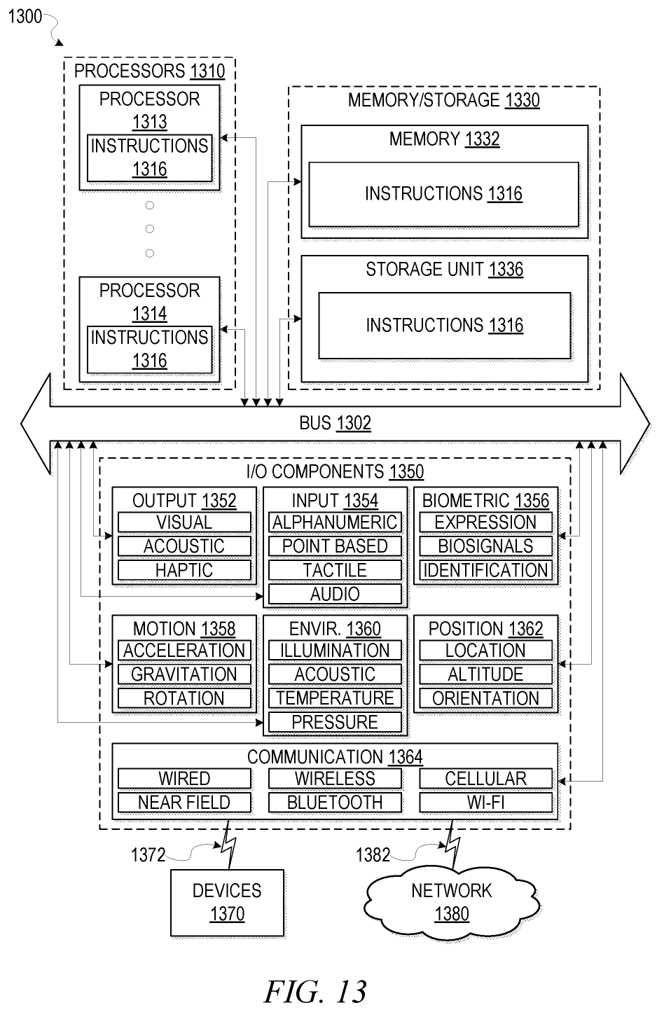

FIG. 13 is a block diagram illustrating components of a machine 1300, according to some example embodiments, able to read instructions from a machine-readable medium (e.g., a machine-readable storage medium) and perform any one or more of the methodologies discussed herein. Specifically, FIG. 13 shows a diagrammatic representation of the machine 1300 in the example form of a computer system, within which instructions 1316 (e.g., software, a program, an application, an applet, an app, or other executable code) for causing the machine 1300 to perform any one or more of the methodologies discussed herein may be executed. These instructions transform the general, non-programmed machine into a particular machine programmed to carry out the described and illustrated functions of the machine 1300 in the manner described herein. The machine 1300 may operate as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. By way of non-limiting example, the machine 1300 may comprise or correspond to a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1316, sequentially or otherwise, that specify actions to be taken by machine 1300. Further, while only a single machine 1300 is illustrated, the term “machine” shall also be taken to include a collection of machines 1300 that individually or jointly execute the instructions 1316 to perform any one or more of the methodologies discussed herein.

The machine 1300 may include processors 1310, memory 1330, and input/output (I/O) components 1350, which may be configured to communicate with each other such as via a bus 1302. In an example embodiment, the processors 1310 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1312 and processor 1314 that may execute instructions 1316. The term “processor” is intended to include multi-core processor that may comprise two or more independent processors (sometimes referred to as “cores”) that may execute instructions contemporaneously. Although FIG. 13 shows multiple processors, the machine 1300 may include a single processor with a single core, a single processor with multiple cores (e.g., a multi-core process), multiple processors with a single core, multiple processors with multiples cores, or any combination thereof.

The memory/storage 1330 may include a memory 1322, such as a main memory, or other memory storage, and a storage unit 1336, both accessible to the processors 1310 such as via the bus 1302. The storage unit 1336 and memory 1332 store the instructions 1316 embodying any one or more of the methodologies or functions described herein. The instructions 1316 may also reside, completely or partially, within the memory 1332, within the storage unit 1336, within at least one of the processors 1310 (e.g., within the processor's cache memory), or any suitable combination thereof, during execution thereof by the machine 1300. Accordingly, the memory 1332, the storage unit 1336, and the memory of processors 1310 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1316. The term “machine-readable medium” shall also be taken to include any medium, or combination of multiple media, that is capable of storing instructions (e.g., instructions 1316) for execution by a machine (e.g., machine 1300), such that the instructions, when executed by one or more processors of the machine 1300 (e.g., processors 1310), cause the machine 1300 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1350 may include a wide variety of components to receive input, provide output, produce output, transmit information, exchange information, capture measurements, and so on. The specific I/O components 1350 that are included in a particular machine will depend on the type of machine. For example, portable machines such as mobile phones will likely include a touch input device or other such input mechanisms, while a headless server machine will likely not include such a touch input device. It will be appreciated that the I/O components 1350 may include many other components that are not shown in FIG. 13. The I/O components 1350 are grouped according to functionality merely for simplifying the following discussion and the grouping is in no way limiting. In various example embodiments, the I/O components 1350 may include output components 1352 and input components 1354. The output components 1352 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1354 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1350 may include biometric components 1356, motion components 1358, environmental components 1360, or position components 1362 among a wide array of other components. For example, the biometric components 1356 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1358 may include acceleration sensor components (e.g., accelerometer), gravitation sensor components, rotation sensor components (e.g., gyroscope), and so forth. The environmental components 1360 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1362 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1350 may include communication components 1364 operable to couple the machine 1300 to a network 1380 or devices 1370 via coupling 1382 and coupling 1372, respectively. For example, the communication components 1364 may include a network interface component or other suitable device to interface with the network 1380. In further examples, communication components 1364 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1370 may be another machine or any of a wide variety of peripheral devices (e.g., a peripheral device coupled via a Universal Serial Bus (USB)).

Moreover, the communication components 1364 may detect identifiers or include components operable to detect identifiers. For example, the communication components 1364 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1364, such as, location via Internet Protocol (IP) geo-location, location via Wi-Fi® signal triangulation, location via detecting a NFC beacon signal that may indicate a particular location, and so forth.

In various example embodiments, one or more portions of the network 1380 may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a POTS network, a cellular telephone network, a wireless network, a Wi-Fi® network, another type of network, or a combination of two or more such networks. For example, the network 1380 or a portion of the network 1380 may include a wireless or cellular network and the coupling 1382 may be a Code Division Multiple Access (CDMA) connection, a Global System for Mobile communications (GSM) connection, or other type of cellular or wireless coupling. In this example, the coupling 1382 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (2GPP) including 2G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1316 may be transmitted or received over the network 1380 using a transmission medium via a network interface device (e.g., a network interface component included in the communication components 1364) and utilizing any one of a number of well-known transfer protocols (e.g., HTTP). Similarly, the instructions 1316 may be transmitted or received using a transmission medium via the coupling 1372 (e.g., a peer-to-peer coupling) to devices 1370. The term “transmission medium” shall be taken to include any intangible medium that is capable of storing, encoding, or carrying instructions 1316 for execution by the machine 1300, and includes digital or analog communications signals or other intangible medium to facilitate communication of such software.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

Although the embodiments of the present invention have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim.

What is claimed is:

1. A system comprising:
one or more processor of a machine;
a machine-readable medium storing instructions that, when executed by the one or more processors, cause the machine to perform operations comprising:
generating a camera node output simulation file including a plurality of entries mimicking output of a set of camera nodes that record images of one or more parking spaces, each entry representing metadata associated with an image of a parking space and including a timestamp and a set of pixel coordinates representing a location of a vehicle within the image, each entry being operable to determine whether the vehicle occupies the parking space; and
simulating the output of the set of camera nodes using the camera node output simulation file, the simulating of the output of the set of camera nodes including:
reading an initial entry from among the plurality of entries according to a chronology of the plurality of entries defined by the time stamps of each entry, the initial entry including an initial time stamp, and an initial set of pixel coordinates, the initial set of pixel coordinates representing an initial location of an initial vehicle within an initial image of an initial parking space;
generating a data packet including the initial entry;
transmitting the data packet to a network-based processing system communicatively coupled to the machine, the network-based processing system configured to determine whether the initial vehicle occupies the initial parking space using the initial set of pixel coordinates.

2. The system of claim 1, wherein simulating the output of the set of camera nodes further includes:
reading a subsequent entry from among the plurality of entries according to the chronology of the plurality of entries defined by the time stamps of each entry, the subsequent entry including a subsequent time stamp and a subsequent set of pixel coordinates;
generating a subsequent data packet including the subsequent entry;
transmitting the subsequent data packet to the processing system communicatively coupled to the machine.

3. The system of claim 2, wherein:
the subsequent entry is a final entry according to the chronology of the plurality of entries; and
the operations further comprise:
receiving a user specified loop parameter value; and
repeatedly transmitting the initial data packet and the subsequent data packet a number of times corresponding to the loop parameter value.

4. The system of claim 2, wherein:
the operations further comprise receiving a user specified interval time parameter value, the interval time parameter value including an interval time for transmitting data packets to the processing system; and
the transmitting of the subsequent data packet is performed after the transmitting of the initial data packet after the interval time.

5. The system of claim 2, wherein:
the initial entry further includes a first camera node identifier, the first camera node identifier identifying a first camera node in the set of camera nodes, the initial set of pixel coordinates representing output of the first camera node; and
the subsequent entry further includes a second camera node identifier, the second camera node identifier identifying a second camera node in the set of camera nodes, the subsequent set of pixel coordinates representing output of the second camera node.

6. The system of claim 2, wherein:
the initial entry further includes a camera node identifier and a first camera identifier, the camera node identifier identifying a camera node in the set of camera nodes, the first camera identifier identifying a first camera of the camera node, the initial set of pixel coordinates representing first metadata associated with a first image recorded by the first camera; and
the subsequent entry further includes the camera node identifier and a second camera identifier, the camera node identifier identifying a camera node in the set of camera nodes, the second camera identifier identifying a second camera of the camera node, the subsequent set of pixel coordinates representing second metadata associated with a second image recorded by the second camera.

7. The system of claim 2, wherein:
the initial set of pixel coordinates correspond to a location of a first object within a first image; and
the subsequent set of pixel coordinates correspond to a location of a second object within a second image.

8. The system of claim 1, wherein the generating of the camera node output simulation file includes generating each entry of the plurality of entries, the generating of each entry including:
selecting a camera node identifier from a list of predefined camera node identifiers, the camera node identifier identifying a camera node, the entry corresponding to metadata associated with an image recorded by the camera node;
selecting an object identifier from a list of predefined object identifiers, the object identifier identifying an object shown in the image;
generating a set of pixel coordinates representing a location of the object within the image; and
assigning a timestamp to the set of pixel coordinates.

9. The system of claim 8, wherein the generating of the camera node output simulation file further includes:
receiving a camera node parameter value, the camera node parameter value specifying a number of camera nodes;
generating the predefined list of camera node identifiers, the list of camera node identifiers including the number of camera nodes specified by the camera node parameter value;
receiving an object parameter value, the object parameter value specifying a number of objects; and
generating the predefined list of object identifiers, the list of object identifiers including the number of objects specified by the object parameter value.

10. The system of claim 8, wherein:
the generating of the camera node output simulation file further includes:
receiving a camera parameter value, the camera parameter value specifying a number of cameras;
generating a predefined list of camera identifiers, the list of camera identifiers including the number of cameras specified by the camera parameter value; and
the generating of each entry further includes:
selecting a camera identifier from the predefined list of camera identifiers.

11. The system of claim 1, wherein:
the generating of the data packet includes formatting the initial entry according to a messaging protocol; and
the data packet includes a destination network address corresponding to the network-based processing system.

12. The system of claim 1, wherein the camera node output simulation file includes a time series table.

13. A method comprising:
generating a camera node output simulation file including a plurality of entries mimicking output of a set of camera nodes that record images of one or more parking spaces, each entry representing metadata associated with an image of a parking space and including a timestamp and a set of pixel coordinates representing a location of a vehicle within the image, each entry being operable to determine whether the vehicle occupies the parking space; and
simulating the output of the set of camera nodes using the camera node output simulation file, the simulating of the output of the set of camera nodes including:
reading an initial entry from among the plurality of entries according to a chronology of the plurality of entries defined by the time stamps of each entry, the initial entry including an initial time stamp, and an initial set of pixel coordinates, the initial set of pixel coordinates representing an initial location of an initial vehicle within an initial image of an initial parking space;
generating a data packet including the initial entry;
transmitting the data packet to a network-based processing system, the network-based processing system configured to determine whether the initial vehicle occupies the initial parking space using the initial set of pixel coordinates.

14. The method of claim 13, wherein simulating the output of the set of camera nodes further includes:
reading a subsequent entry from among the plurality of entries according to the chronology of the plurality of entries defined by the time stamps of each entry, the subsequent entry including a subsequent time stamp and a subsequent set of pixel coordinates;
generating a subsequent data packet including the subsequent entry;
transmitting the subsequent data packet to the processing system.

15. The method of claim 14, wherein:
the subsequent entry is a final entry according to the chronology of the plurality of entries; and
the operations further comprise:
receiving a user specified loop parameter value; and
repeatedly transmitting the initial data packet and the subsequent data packet a number of times corresponding to the loop parameter value.

16. The method of claim 14, wherein:
the operations further comprise receiving a user specified interval time parameter value, the interval time parameter value including an interval time for transmitting data packets to the network-based processing system; and
the transmitting of the subsequent data packet is performed after the transmitting of the initial data packet after the interval time.

17. The method of claim 14, wherein:
the initial entry further includes a first camera node identifier, the first camera node identifier identifying a first camera node in the set of camera nodes, the initial set of pixel coordinates representing output of the first camera node; and
the subsequent entry further includes a second camera node identifier, the second camera node identifier identifying a second camera node in the set of camera nodes, the subsequent set of pixel coordinates representing output of the second camera node.

18. The method of claim 14, wherein:
the initial entry further includes a camera node identifier and a first camera identifier, the camera node identifier identifying a camera node in the set of camera nodes, the first camera identifier identifying a first camera of the camera node, the initial set of pixel coordinates representing first metadata associated with a first image recorded by the first camera; and
the subsequent entry further includes the camera node identifier and a second camera identifier, the camera node identifier identifying a camera node in the set of camera nodes, the second camera identifier identifying a second camera of the camera node, the subsequent set of pixel coordinates representing second metadata associated with a second image recorded by the second camera.

19. The method of claim 14, wherein:
the initial set of pixel coordinates correspond to a location of a first object within a first image; and
the subsequent set of pixel coordinates correspond to a location of a second object within a second image.

20. A non-transitory machine-readable storage medium, and embodying instructions that, when executed by one or more processors of a machine, cause the machine to perform operations comprising:
generating a camera node output simulation file including a plurality of entries mimicking output of a set of camera nodes that record images of one or more parking spaces, each entry representing metadata associated with an image of a parking space and including a timestamp and a set of pixel coordinates representing a location of a vehicle within the image, each entry being operable to determine whether the vehicle occupies the parking space; and
simulating the output of the set of camera nodes using the camera node output simulation file, the simulating of the output of the set of camera nodes including:
reading an initial entry from among the plurality of entries according to a chronology of the plurality of entries defined by the time stamps of each entry, the initial entry including an initial time stamp, and an initial set of pixel coordinates, the initial set of pixel coordinates representing an initial location of an initial vehicle within an initial image of an initial parking space;
generating a data packet including the initial entry;
transmitting the data packet to a network-based processing system, the network-based processing system configured to determine whether the initial vehicle occupies the initial parking space using the initial set of pixel coordinates.
